(19) United States
(12) Patent Application Publication
(10) Pub. No.: US 2026/0011946 A1
(43) Pub. Date: Jan. 8, 2026

(54) SOCKET FOR TRANSMITTING HIGH-FREQUENCY CURRENT, PLUG-IN SYSTEM, AND ELECTROSURGICAL DEVICE

(71) Applicant: Karl Leibinger Asset Management GmbH & Co. KG, Mühlheim an der Donau (DE)

(72) Inventors: Stefan Häringer, Winden im Elztal (DE); Noruz Bagheri, Freiburg (DE)

(21) Appl. No.: 19/261,547

(22) Filed: Jul. 7, 2025

(30) Foreign Application Priority Data
Jul. 8, 2024 (DE) 102024119320.4

(51) Int. Cl. H01R 13/10; H01R 13/17; H01R 13/187; H01R 13/50

(52) U.S. Cl. CPC H01R 13/10; H01R 13/17; H01R 13/187; H01R 13/50; H01R 2201/12

(57) ABSTRACT

A socket (SB) for transmitting high-frequency current to a plug connector (ST), for an electrosurgical application includes a plug contact opening (SA), a connector base (SG) arranged opposite the plug contact opening (SA), and a housing (G) having an inner circumference (GU). A first contact element (K1) for transmitting high-frequency current to the plug connector (ST) is arranged on the inner circumference (GU), and a second contact element (K2) is arranged on the connector base (SG). The second contact element (K2) is provided for transmitting high-frequency current to the plug connector (ST) and is constantly electrically connected to the first contact element (K1) such that the first and the second contact elements (K1, K2) have the same electrical potential. A plug-in system (S) and an electrosurgical device (EG) with such a socket (SB) are also provided.

### CROSS-REFERENCE TO RELATED APPLICATION

The present application is related and has right of priority to German Patent Application No. DE102024119320.4 filed on Jun. 8, 2024, which is incorporated by reference in its entirety for all purposes.

### TECHNICAL FIELD

The invention relates generally to a socket for transmitting high-frequency current to a plug connector, in particular for an electrosurgical application. The invention further relates generally to a plug-in system having a plug connector and such a socket, and to an electrosurgical device having such a plug-in system or such a socket.

### BACKGROUND

In electrosurgical devices, plug connections are generally present in order to connect an electrosurgical instrument, such as a monopolar laparoscopic instrument, to an energy supply unit, such as a high-frequency current generator. The plug connections can be in the form of a single plug-in system or a multiple plug-in system. For reliable surgical treatment of a patient using such electrosurgical devices, it is essential that an incorrect plug contact is reliably detected. This is the case because an impairment of the treatment of a patient due to a contact fault in the plug connection is of course undesirable.

Approaches for detecting a correct position of a plug connector in a socket are already known from the prior art. EP 2 486 885 A1 teaches a universal socket having a plug detection device which is arranged at the base of a plug contact opening. The plug detection device is realized as a contact pin, as a reed contact, or as a microswitch. The plug detection device generates a signal which is representative of the insertion state of the plug connection. Once the feedback from the plug detection device has been received, the control device of the surgical device generates a signal, which ensures that a current is released on the appropriate contact elements in the plug contact openings.

Such an approach increases the complexity of the surgical device, however. This is the case because the additional read-out of a signal of a plug detection device is an additional source of error, which must be prevented both by the hardware and the software.

### BRIEF SUMMARY

Example aspects of the invention provide an approach for reliably detecting a correct, or faulty, plug connection, which is distinguished by a simple design.

In example aspects, the invention relates to a socket for transmitting high-frequency current to a plug connector, in particular for an electrosurgical application. The socket has a plug contact opening, a connector base arranged opposite the plug contact opening, and a housing having an inner circumference. At least one first contact element for transmitting high-frequency current to the plug connector is arranged on the inner circumference. A second contact element is arranged on the connector base.

According to example aspects of the invention, the second contact element and the first contact element are provided for transmitting high-frequency current to the plug connector. The first and the second contact elements are constantly electrically connected, so that the first and the second contact elements have the same electrical potential.

Example aspects of the invention are based on the finding that plug contact detection can be carried out without additional sensors by conducting a test voltage across the plug connection prior to an actual operation of the surgical device, and only when the evaluation of the test voltage is positive is the actual operation of the surgical device permitted. The proper plug contact can also be monitored during the actual operation of the surgical device by applying the test voltage. In order to be able to reliably rule out a contact in the plug connection that is not proper in such a sensor-free plug contact detection, according to example aspects of the invention, the socket is to be designed such that the plug connector can be contacted at the tip and at the periphery thereof for transmitting the test voltage, so that a test voltage can be applied to the plug connection at at least one point (tip or periphery). In this way, in particular, a plug connection having geometrically slightly different plug connectors can be reliably detected.

According to one possible example embodiment, the second contact element is formed by a spring, for example, a conical spring. In such an example embodiment, a plug contact opening-side end of the spring is designed to electrically contact the plug connector, and a connector base-side end of the spring is designed to mechanically support and electrically contact the spring on the connector base.

Preferably, the second contact element is in multiple parts and has a spring, which preloads a contact tip of the second contact element in the direction of the plug contact opening. For example, the second contact element can be a spring-loaded contact pin for this purpose. Such an approach is reliably and easily implemented, since spring-loaded contact pins are known and are available on the market, having been adequately tested.

Preferably, the first contact element is in the form of a spring bushing. By a spring bushing, high-frequency current can be reliably transmitted to a peripheral surface of a plug connector. In addition, an insertion resistance which is easily perceived by the user is definable by a spring bushing.

Preferably, a spring preload of the second contact element is less than, in particular substantially less than, a spring preload of the spring bushing. As a result, the insertion feel can also be defined by the spring bushing without the user becoming uncertain due to an additional insertion resistance caused by the second contact element.

According to a preferred example embodiment, the first and the second contact elements are accommodated in an electrically conductive contact element carrier, which is accommodated in the housing. As a result, it can be easily ensured that the first and the second contact elements have the same electrical potential.

Preferably, the second contact element has a shoulder, which is supported against the contact element carrier. In this way, reliable support of the second contact element can be easily achieved.

Preferably, the socket includes a third contact element, which, similarly to the first and the second contact elements, is designed to transmit high-frequency current to the plug connector. The third contact element is electrically separated from the first and the second contact elements. Due to such a construction, a test voltage can be applied to the plug connector via the first and/or the second contact element, and can be transmitted across the socket again via the third contact element. The third contact element is arranged on the inner circumference of the housing and is preferably in the form of a spring bushing.

The socket can be an integral part of a plug-in system consisting of a plug connector and a socket. The socket can be an individual socket or a multiple socket outlet in which multiple plug contact openings are combined in a common housing. In such an example embodiment as a multiple socket outlet, one, multiple, or all socket(s) can be designed as described above.

The socket or the plug-in system can be an integral part of an electrosurgical device, for example, a high-frequency current generator. The socket or the plug-in system can form the electrical interface to an electrosurgical hand-held instrument, for example, a laparoscopic instrument.

### BRIEF DESCRIPTION OF THE DRAWINGS

Exemplary embodiments of the invention are described in detail on the basis of the figures. Wherein:

FIG. 1 shows a socket according to an example embodiment in an isometric view;

FIG. 2 shows a top view of the socket;

FIG. 3 shows a sectional view of the socket;

FIG. 4 shows a schematic sectional view of a contact element of the socket;

FIG. 5 shows a schematic sectional view of a socket according to an another example embodiment;

FIG. 6 shows a sectional view of a plug-in system with a socket and a plug connector; and

FIG. 7 shows an electrosurgical device with an electrosurgical hand-held instrument connected thereto.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

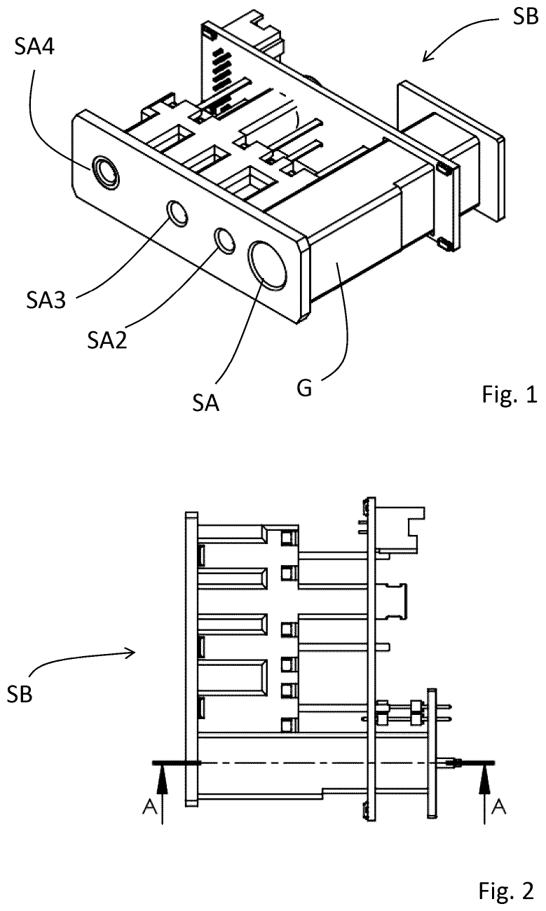

FIG. 1 shows an exemplary embodiment of a socket SB in an isometric view. The socket SB is a multiple socket outlet and has multiple plug contact openings SA, SA2, SA3, SA4 arranged in a row. The socket SB has an electrically insulating housing G for accommodating and supporting the individual sockets. FIG. 2 shows a top view of the socket SB, a sectional plane A-A being defined.

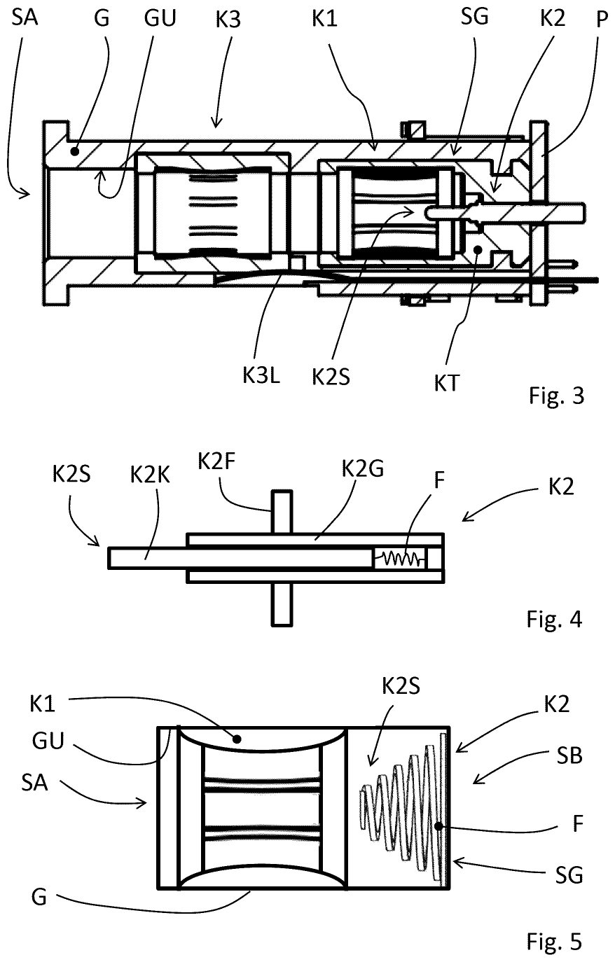

FIG. 3 shows a sectional view of the socket SB according to the sectional plane A-A defined in FIG. 2. The socket SB is designed to accommodate a plug connector (not shown in FIG. 3) having a round cross-section. The electrically insulating housing G has the plug contact opening SA at one end and a connector base SG at the other end. A first contact element K1 is arranged on the inner circumference GU of the housing G. The first contact element K1 is accommodated in an electrically conductive contact element carrier KT and is in the form of a spring bushing. The first contact element K1 is designed to transmit a high-frequency voltage to a plug connector (not shown in FIG. 3).

A second contact element K2, which is in the form of a spring-loaded contact pin, is arranged in a bore in the contact element carrier KT. An exemplary design of the second contact element K2 is explained in greater detail in FIG. 4. A contact tip K2S of the second contact element K2 points in the direction of the plug contact opening SA and protrudes into the inner circumference of the first contact element K1. The two contact elements K1, K2 have the same electrical potential, since the two contact elements K1, K2 are electrically conductively connected to the contact element carrier KT.

The socket SB according to the exemplary embodiment shown in FIG. 3 also includes a third contact element K3. The third contact element K3 is arranged between the plug contact opening SA and the first contact element K1 on the inner circumference GU of the housing G, and is in the form of a spring bushing. The third contact element K3 is electrically separated from the contact element carrier KT by the housing G. A circuit board P is arranged on the side of the housing G opposite the plug contact opening SA. The circuit board P has strip conductors (not shown in FIG. 3) via which electrical contact is established with the contact element carrier KT and, via the line K3L, with the third contact element K3.

FIG. 4 shows a schematic sectional view of the second contact element K2 according to one possible exemplary embodiment. The second contact element K2 is in multiple parts and has a housing K2G and a piston K2K guided in the housing. The piston K2K protrudes partially out of the housing K2G, wherein the contact tip K2S is formed on the protruding end of the piston K2K. A spring F is arranged at the opposite end of the piston K2K, via which the piston K2K is supported against the housing K2G.A shoulder K2F is arranged on the housing K2G, via which the second contact element K2 can be supported against the contact element carrier KT. The distance coverable by the piston K2K between the end positions of the piston is, for example, between three (3) millimeters and seven (7) millimeters.

FIG. 5 shows a schematic sectional view of a socket SB according to a second exemplary embodiment. In contrast to the exemplary embodiment shown in FIG. 3, this socket SB has only two contact elements, specifically the first contact element K1, which is in the form of a spring bushing K1, and the second contact element K2, which is in the form of a conical spring F. A connector base-side end of the conical spring F is used for mechanical support and electrical contacting, whereas the contact tip K2S for contacting the plug connector (not shown in FIG. 5) is formed on the plug contact opening-side end of the conical spring F. The electrical connection between the two contact elements K1, K2 is not explicitly shown in FIG. 5.

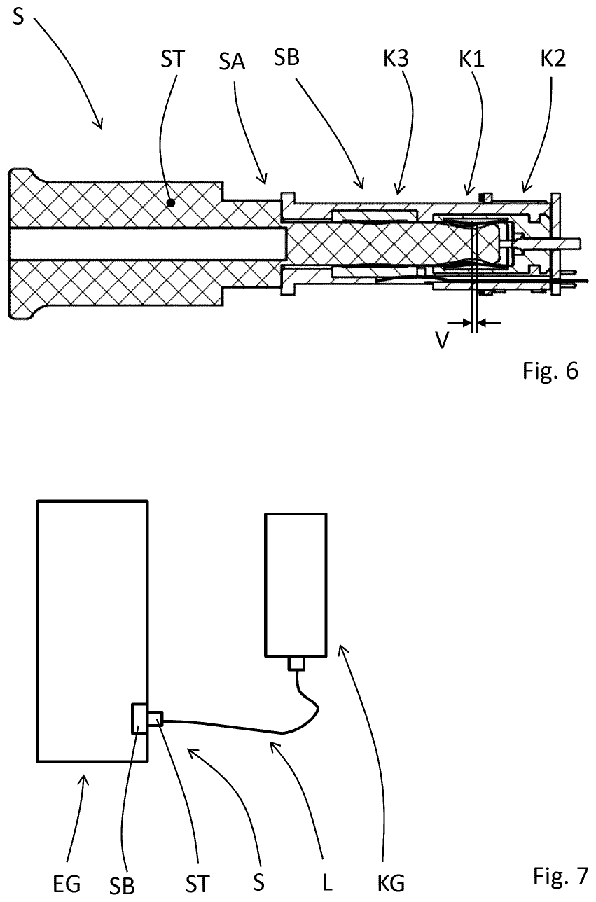

FIG. 6 shows a plug-in system S with a plug connector ST and a socket SB, which, in the view according to FIG. 6, is designed by way of example according to the exemplary embodiment shown in FIG. 1 through FIG. 3. The plug connector ST has a round cross-section with a variable diameter on the socket-side end of the plug connector. In the view according to FIG. 6, the plug connector ST is inserted into the plug contact opening SA in the socket SB up to the stop. The smallest diameter of the first contact element K1, which is in the form of a spring bushing, is offset with respect to the smallest diameter of the plug connector ST in the insertion direction, as is shown by way of example in FIG. 6 by the offset V. As a result, the peripheral surface of contact of the plug connector ST with the first contact element K1 is not clearly defined, and therefore a contact fault can occur. The electrical contact with the plug connector ST can be reliably established, however, by the second contact element K2, which is in the form of a spring-loaded contact pin in this case. As a result, the socket SB can be used together with slightly differently shaped plug connectors ST.

FIG. 7 schematically shows an electrosurgical device EG, for example, a high-frequency current generator. The electrosurgical device EG can be connected to an electrical network (not shown in FIG. 7) as the energy source, and has a plug-in system S with a socket SB and a plug connector ST. The plug-in system S can be designed, for example, as shown in FIG. 6. A cable L is connected to the plug connector S, which cable is connected to an electrosurgical hand-held instrument KG, for example, a laparoscopic instrument, such as a hook electrode. A correct plug contact of the plug-in system S can be detected, by way of example, by transmitting a test voltage across the plug-in system S, in that the test voltage is transmitted from the high-frequency current generator EG via the first and/or the second contact element K1, K2 to the plug connector ST.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### LIST OF REFERENCE SIGNS

S plug-in system
ST plug connector
SB socket
A-A sectional plane
SA, SA2, SA3, SA4 plug contact opening
SG connector base
G housing
Gu inner circumference
K1 first contact element
K2 second contact element
K2S contact tip
K2G housing
K2K piston
F spring
K2F shoulder
K3 third contact element
K3L line
KT contact element carrier
P circuit board
V offset
EG electrosurgical device
L cable
KG electrosurgical hand-held instrument

1-11. (canceled)

12. A socket (SB) for transmitting high-frequency current to a plug connector (ST) for an electrosurgical application, comprising:
a plug contact opening (SA);
a connector base (SG) arranged opposite the plug contact opening (SA);
a housing (G) having an inner circumference (GU);
a first contact element (K1) for transmitting high-frequency current to the plug connector (ST) arranged on the inner circumference (GU) of the housing (G); and
a second contact element (K2) arranged on the connector base (SG),
wherein the second contact element (K2) is configured for transmitting high-frequency current to the plug connector (ST) and is constantly electrically connected to the first contact element (K1) such that the first and the second contact elements (K1, K2) have a common electrical potential.

13. The socket (SB) of claim 12, wherein the second contact element (K2) comprises a spring (F), a plug contact opening-side end of the spring (F) is configured to electrically contact the plug connector (ST), and a connector base-side end of the spring (F) is configured to mechanically support and electrically contact the spring (F) on the connector base (SG).

14. The socket (SB) of claim 12, wherein the second contact element (K2) is a multi-part contact element and comprises a spring (F), and the spring (F) preloads a contact tip (K2S) of the second contact element (K2) towards the plug contact opening (SA).

15. The socket (SB) of claim 14, wherein the second contact element (K2) comprises a spring-loaded contact pin.

16. The socket (SB) of claim 12, wherein the first contact element (K1) comprises a spring bushing.

17. The socket (SB) of claim 16, wherein a spring preload of the second contact element (K2) is less than a spring preload of the spring bushing.

18. The socket (SB) of claim 12, wherein the first contact element (K1) and the second contact element (K2) are accommodated in an electrically conductive contact element carrier (KT) located in the housing (G).

19. The socket (SB) of claim 18, wherein the second contact element (K2) comprises a shoulder (K2F), and the second contact element (K2) is supported against the contact element carrier (KT) via the shoulder (K2F).

20. The socket (SB) of claim 12, further comprising a third contact element (K3) electrically separated from the first contact element (K1), the third contact element (K3) arranged on the inner circumference (GU) of the housing (G), the third contact element (K3) configured to transmit high-frequency current to the plug connector (ST).

21. A plug-in system (S) for transmitting high-frequency current for an electrosurgical application, comprising:
a plug connector (ST); and
the socket (SB) of claim 12.

22. An electrosurgical device (EG) for generating high-frequency current, comprising one or both of the socket (SB) of claim 12 and the plug-in system (S) of claim 21.
